(19) United States
(12) Patent Application Publication
(10) Pub. No.: US 2008/0271082 A1
(43) Pub. Date: Oct. 30, 2008

(54) USER CONTROLLED MULTIMEDIA TELEVISION BROADCAST ON SINGLE CHANNEL

(76) Inventors: Rebecca Carter, Rio Rancho, NM (US); Mohamad A. Dagher, San Dimas, CA (US)

Correspondence Address: V. Gerald Grafe, esq., P.O. Box 2689, Corrales, NM, 87048, US

(21) Appl. No.: 11/741,619

(22) Filed: Apr. 27, 2007

(51) Int. Cl. H04N 5/445

(52) U.S. Cl. 725/51; 345/157

(57) ABSTRACT

A system and method for the user controlled television broadcast system packaging a live, simultaneous, multiple feed telecast and pre-determined multimedia content over a single channel with viewer manipulation components and methods to protect and generate commercial content are disclosed.

### TECHNICAL FIELD OF THE INVENTION

User controlled television broadcast system packaging a live, simultaneous, multiple feed telecast and pre-determined multimedia content over a single channel with viewer manipulation components and methods to protect and generate commercial content.

### BACKGROUND OF THE INVENTION

Interactive, multi-camera television broadcast systems are being introduced as an enhanced entertainment product. U.S. Pat. No. 7,079,176, incorporated herein by reference, concerns a presentation of the live event that can be personalized for the viewer through the provision of various options, including multiple video streams, associated with different camera angles, for example, and integrated audio and graphics segments. Further, information obtained from related Web sites can be integrated into the live program. Various video and audio streams can be collected from a live event and forwarded to a central control studio. Signals are digitized and compressed in digital compressors and then combined with special data codes into a “digital package,” and subsequently, transmitted over a cable distribution system. Once received at a viewer home, the signals are received and processed in an interactive digital cable box. Selections of the video, audio, graphics displays and/or Web pages can be made as a function of immediate viewer entries, or to interrogatory responses presented at the beginning or during the program, or based on a pre-stored viewer profile. Once a decision is made to switch from one video to another video option, the digital switch is performed seamlessly. The digital interactive system is based upon seamless branches which occur in the course of full-motion video.

The system taught in U.S. Pat. No. 7,079,176, however, requires multiple channels to present interactivity, does not give the viewer comprehensive manipulation of the full compliment of multimedia content, the design promotes evasive methods for viewers to skip commercials and it does not include methods to generate unique commercial applications.

U.S. Pat. No. 5,953,046, incorporated herein by reference, concerns a system for providing, in a television system, the combination, transmission, and reception of multiple video presentations over a single channel of a television distribution system. Presentations can be concurrently broadcast for viewing by many users, as well as interactively requested for display by many (potentially one thousand or more) individual users. A presentation consists of a sequence of images which reproduce a motion or still image video presentation for the user when displayed. The signal is transmitted in a standard television format, and consists of a sequence of video images from the various presentations being transmitted. A user terminal receiving the transmitted signal is selectably operable to display one of the multiple transmitted presentations with accompanying audio. The terminal identifies the video images on an associated television receiver. The number of concurrent presentations and the degree of motion in the presentations are variable. User requested interactive instructions between a user at the terminal end and the presentation system are transmitted by an associated telephone line or other communications link. A selected group of continuously transmitted interactive information can also be accessed without the use of a communications link.

The system taught in U.S. Pat. No. 5,953,046, however, teaches that a user terminal receiving the transmitted signal is selectably operable to display only one of the multiple transmitted presentations with accompanying audio, only on an associated television receiver and does not generate commercial applications.

U.S. Pat. No. 5,894,320, incorporated herein by reference, concerns a system wherein a television viewer can select among a choice of available camera angles and audio feeds when viewing a sporting event such as a football game without changing the television channel. Audio, video and control data is transmitted in a packetized data stream with control data providing a pre-assigned channel designation (e.g., channel 10 for network X). A set-top terminal receives and processes the data stream according to user-provided commands. The terminal includes software which can be downloaded via the data stream or installed locally. The control data in the data stream is used to provide an on-screen graphical display on the television that allows the user to select the audio and video which correspond to certain areas of the football stadium, for example. Optionally, the viewer may select alternative story lines in a movie or similar program. A default setting provides primary audio and video signals. Alternative audio and video signals are selected by the user and mapped to the channel designator of the primary signal so that the different camera angles and audio feeds may be seen and heard. The viewer is therefore given the opportunity to customize the programming to enhance the entertainment or educational value.

The system taught in U.S. Pat. No. 5,894,320, however, delivers a choice of available camera angles and audio feeds to a viewer only on a television device.

U.S. Pat. No. 5,600,368, incorporated herein by reference, concerns an interactive television system that has a set-top box adapted for use with a television and a remote control handset. The set-top box is connected to receive a television broadcast that is filmed using multiple cameras situated at various camera viewpoints. The television broadcast has a primary channel, with which the viewer is familiar as carrying the desired television program, and multiple virtual channels associated with the primary channel. The virtual channels carry video signals from the multiple different cameras covering the event. The remote control handset has dedicated camera control buttons for selecting corresponding virtual channels to allow the viewer to choose a desired camera viewpoint. The dedicated camera control buttons are arranged in an intuitive pattern that correlates to the camera viewpoints.

The system taught in U.S. Pat. No. 5,600,368, however, provides that the broadcast is available only via television and it promotes the evasion of commercial content.

U.S. Pat. No. 6,539,545A, incorporated herein by reference, concerns a system and method for the simultaneous transmission and rendition of multiple encoded digital video signal streams in an interactive television application are disclosed. Simultaneous transmission and rendition of multiple encoded digital video signal streams in an interactive television application generally comprises modifying at least one of the multiple encoded video streams broadcast from a broadcast center for repositioning the at least one of the multiple encoded video stream for display, interleaving the modified multiple encoded video streams comprising the at least one modified encoded video stream into a single composite interleaved video stream, and outputting the single composite video stream. The method can further comprise receiving the multiple encoded video streams from a broadcast center. Each of the multiple encoded video streams is preferably encoded using MPEG-1 or MPEG-2 compression technology. The method for simultaneous rendering of multiple encoded video streams, wherein each of the multiple encoded video streams is encoded using a compression technology selected from the group consisting of MPEG-1 and MPEG-2.

The system taught in U.S. Pat. No. 6,539,545A, however, is specific in methods only to transmit and render multiple feeds and not methods for a comprehensive end user application that gives the end user the means to fully manipulate the multimedia signals and a variety of other applications in their own environment, it is specific in utilizing MPEG-1 and MPEG-2 compression technology which is known to consume a great deal of bandwidth that ultimately challenges adaptation of a broad user population and it is not specific in methods to guarantee the protection of commercial applications that are traditionally broadcast with the main live signal.

### SUMMARY OF THE INVENTION

The present invention comprises a consumer based television broadcast architecture that delivers an interactive, multimedia broadcast to a single channel viewer's personal production suite where each viewer can manipulate the broadcast to their liking.

This architecture operates through a comprehensive production suite that accepts the live, simultaneous multiple feed telecast from the editing client and combines it with pre-determined, recorded video and audio, data, graphics, e-based applications and houses it for interactive transmission.

The interactive multimedia single channel viewer's personal production suite is then accessible to multiple individual viewers via web based devices, e.g., computer, internet television, internet telephone, mobile phone, PDA, broadband instruments and such other internet capable devices as may in the future be web enabled as these example devices present.

The present invention can protect commercial content, which often pays for broadcasting, by encapsulating the main feed from the live broadcast that houses commercial segments into a secured window that ensures the delivery to the viewer via the personal production suite while not interrupting viewer manipulation. The present invention also can generate other commercial applications that are only achievable because of the architecture of the present invention.

These and other advantages and novel features of the present invention will become apparent to those skilled in the art upon studying this application in conjunction with the accompanying drawings and the claims appended hereto.

### BRIEF DESCRIPTION OF THE DRAWINGS

FIG. 1 is a flow diagram of the overall system of the simultaneous multimedia broadcast, the capture, conversion, packetizing and delivery mechanisms to the end product being the viewer's personal production suite.

FIG. 2 is an illustration of the architecture capabilities of the interactive viewer's personal production suite to receive, present and manipulate the multimedia options.

FIG. 3 is an illustration of an example of the viewer's personal production suite.

FIG. 4 is an illustration of the invention in terms of capturing and transmitting the main broadcast feed housing commercial content and providing functionality in the system to generate other commercial content.

### DETAILED DESCRIPTION OF THE INVENTION

A system and method for the user controlled television broadcast system packaging a live, simultaneous, multiple feed telecast and pre-determined multimedia content over a single channel with viewer manipulation components and methods to protect and generate commercial content are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention

The present invention provides a television broadcast architecture that delivers an interactive, comprehensive, simultaneous, multiple feed broadcast to multiple individuals over their single channel viewer's personal production suite where each viewer can manipulate the menu of choice to their liking. This architecture operates through a comprehensive production suite that accepts the live, multiple video/audio, simultaneous television broadcast feed from an editing client and combines it with pre-determined, recorded video and audio, data, graphics and e-based applications. The packetized broadcast is then streamed, en masse, to the unique viewer production suite over a single channel being accessible on their web based devices, such as a computer, internet television, internet telephone, cellular telephone, personal digital assistants, smartphones and such other internet capable devices as may in the future be web enabled as these example devices present.

The present invention can protect the advertising industry by encapsulating the main feed from the live broadcast that delivers the traditional commercial content into a secured window that ensures the delivery to the viewer via the personal production suite and the personal device that the viewer decides to use to view the broadcast. The present invention promotes advertising with commercial options that are only achievable because of the design of the viewer's personal production suite.

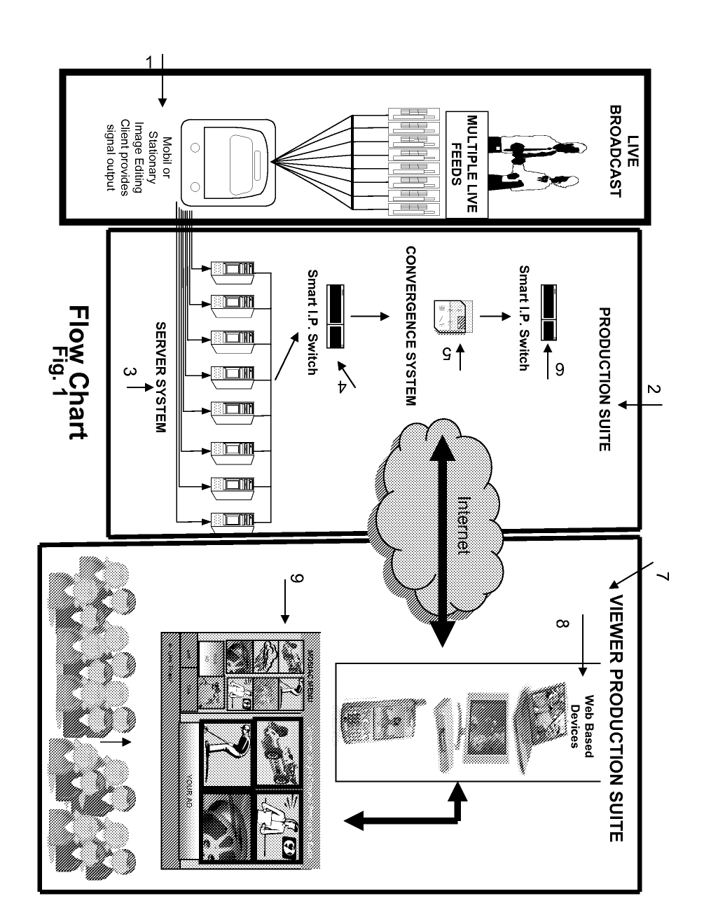

FIG. 1 is an illustration of the present invention in terms of a flow chart demonstrating a live television broadcast (1); the production suite (2) that will process, house and transmit the packaged live and pre-determined multimedia content to multiple individuals on web based devices with the single channel viewer's personal production suite (7).

FIG. 1 represents the present invention in terms of a flow chart demonstrating the process of the splitting of the original live multiple video signals in the client editing source (1) with signal splitters and amplifiers then directing the secondary live multiple video signals from the client editing source into a server system (3).

FIG. 1 further represents the present invention in terms of a method of capturing the simultaneous, multiple live television broadcast feeds through a server system (3) that provides multiple video and audio signal inputs and switching, compression architecture which will reduce the size of and packetize the live multiple signals with encoding schemes, high speed digital transmission of real time, full motion video/audio image signals, file format and encryption formats to a level where it becomes feasible to ultimately transmit over web based devices (8).

FIG. 1 further represents the present invention in terms of a method to digitize the video images at this stage (3) where the signals are catalogued thus allowing the software on the remote end to reconstruct the images each in its corresponding window (9). This allows the viewer to select from the multiple camera signals to be viewed in the personal production suite (9).

FIG. 1 further represents the present invention in terms of a method of streaming the packetized live feeds (3) through a high speed routing and switch system (4) that will analyze the multiple live camera traffic, such as DNS and SNMP queries, set up a virtual circuit in an ATM switch for the long-duration traffic of the multiple live camera stream for flow at high speeds. The IP Switch can use the General Switch Management Protocol (GSMP) for call setup and the Ipsilon Flow Management Protocol (IFMP) for flow redirection to the convergence system (5).

FIG. 1 further represents the present invention in terms of the convergence system (5), a web based system that can create, house and transmit the interactive multimedia broadcast to the end user's personal production suite. Example embodiments of the convergence system comprise an embedded operating system, content management system, cascading operatives, secure encryption, network administrators, PHP script program, extended object oriented portal system, two-way high speed transmission system, multiple video channel loop-through, multiple image size configurations, subscription mechanisms, password protection and two-way flexible e-module for manipulation of any e-process such as blogs, instant messaging, URL links.

FIG. 1 further represents the present invention in terms of a method of the streaming of the packetized content from the convergence system (5) through a two-way high speed routing and switch system (6) that will analyze the content traffic, such as DNS and SNMP queries, set up a virtual circuit in an ATM switch for the long-duration traffic of the multimedia content stream for flow at high speeds. The IP Switch can use the General Switch Management Protocol (GSMP) for call setup and the Ipsilon Flow Management Protocol (IFMP) for flow redirection to/from web based devices (8).

FIG. 1 further represents the present invention in terms of a method of delivering the broadcast package to web based devices (8) with the support of the convergence system (5) interactive architecture that includes server, browser and client software integrated software for web based devices, i.e. computers, internet television, internet telephone, cellular telephone, personal digital assistants, smartphones and such other internet capable devices as may in the future be web enabled as these example devices present.

FIG. 1 further represents the present invention in terms of a representation of the single channel viewer's personal production suite (9).

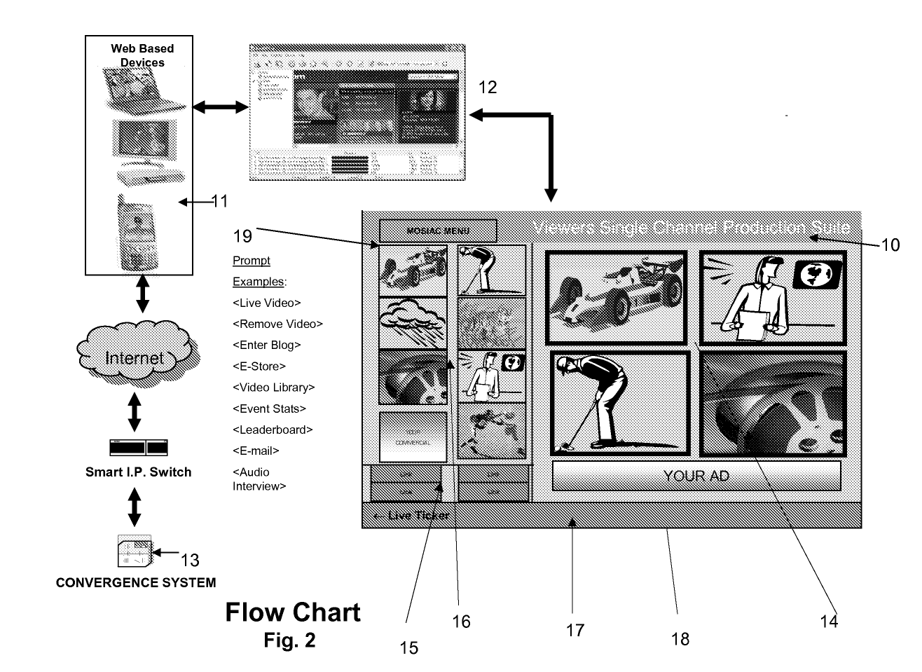

FIG. 2 represents the present invention in terms of an architecture that operates the single channel viewer's personal production suite (10) giving the viewer interactive control of the multimedia broadcast. The starting point is any web based device (11) operated by the viewer. Upon viewer access to their web based device (11), they will launch their web browser and enter a pre-determined Uniform Resource Locator (URL) opening the home page (12) for the telecast that is housed in the convergence system (13). Following further instructions the viewer will activate their personal suite (10).

FIG. 2 further represents the present invention in terms of a sample screen template for the viewer's personal production suite (10) that will display the multimedia telecast and house interactive functions for viewer control. The screen template can be pre-determined in design to display the menu of live feed options (16), windows-in-screen boxes to house viewer selected feed options (14) and other pre-determined video, audio, data, graphics or e-links (15) and production controlled displays (17, 18).

FIG. 2 further represents the present invention in terms of standard web based command navigation. As viewers navigate throughout their production suite, required prompts (19) can appear, creating the interaction between the viewer and the convergence system that can include selecting a camera feed from the menu for activation in the main screen, manipulating the audio switch prompt, access multi-functional prompts for display of pre-determined video, audio, graphics, data and e-based applications (14,15, 17, 18).

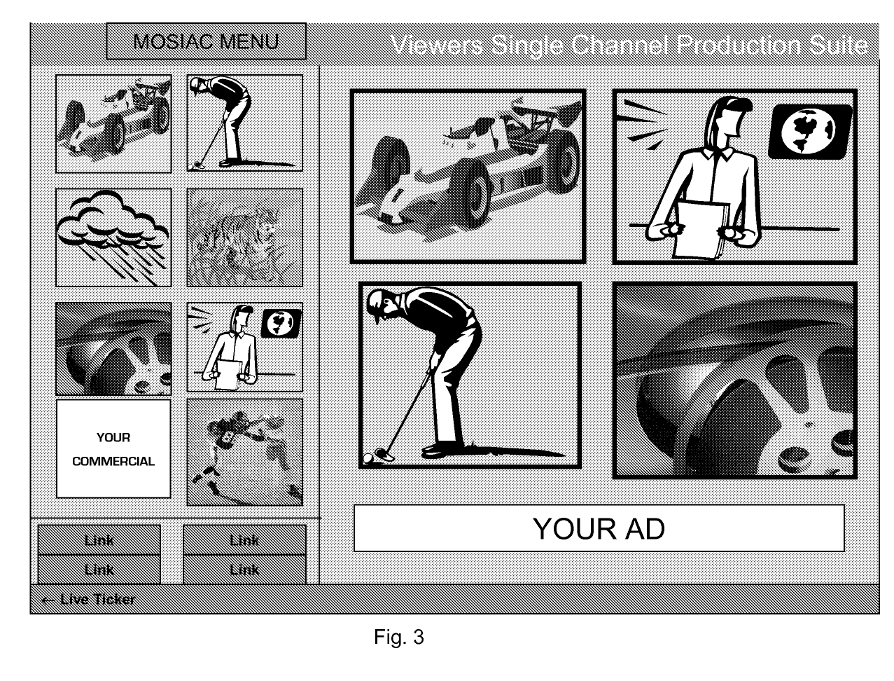

FIG. 3 represents the present invention in a sample of a viewer's personal production suite. The personal production suite can be utilized in a variety of ways. For example: a viewer selecting live camera feeds of basketball and figure skating, while at the same time requesting information on the type of basketball shoes a player is wearing, and e-mailing this link to a friend; then switching from skating to live soccer action and joining a blog on the acquisition of David Beckham, then going full screen to the final 2 minutes of the NBA Finals game and, of course, going back to the home screen after the Dallas Mavericks win the NBA Championships—all while seeing the leaderboard tracker of The Masters at Augusta National Golf Club.

Another example of the method of the present invention represented in FIG. 3: A viewer can request simultaneous, multiple channel capture over a single channel in their personal production suite broadcasting channels of choice such as CNN, ESPN, MSNBC, CSPAN, History, Cooking, Movie Channel, Local CBS, PBS, etc.

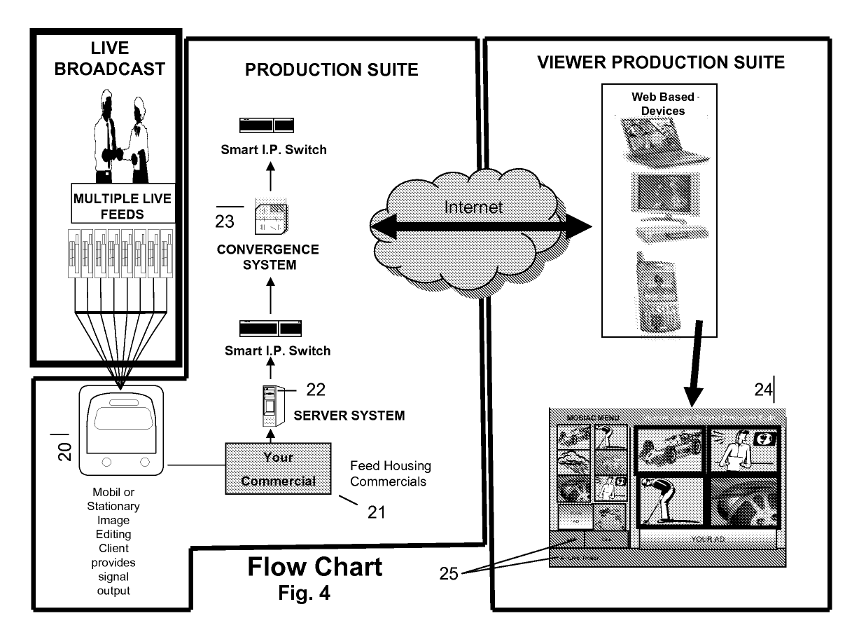

FIG. 4 represents the present invention in terms of a diagram demonstrating a method of protecting commercial content applications by identifying the standard switch from the live telecast to pre-determined commercial content (21) and deploying the commercial signal into a pre-determined screen-in-window (24) for the duration of the commercial segment within the viewer's personal production suite while not drastically interrupting the viewer's manipulation of the broadcast.

FIG. 4 further represents the present invention in terms of the specific process of identifying the switch from live broadcast to commercial content (21) with head end encoding and encrypting the feed as it is streamed from the editing client output (20) to the server system (22) that will transmit it through the production suite switches to the convergence system (23) where it will be embedded in the screen architecture guaranteeing the delivery to the viewer's personal production.

FIG. 4 further represents the present invention in terms of a specific process of housing other pre-determined commercial content in convergence system (23) with coding that will identify the feed and encryption that will stream the feed into pre-determined space (25) in the viewer's personal production.

Although the present invention has be described in detail with respect to certain embodiments and examples, variations and modifications exist which are within the scope of the present invention as defined in the following claims.

What is claimed is:

1. A system for providing a single channel viewer controlled television broadcast carrier system, comprising:
a means for provided packaged content comprising means for packaging simultaneous streaming of a plurality of sources, at least one of which is chosen from the group consisting of: (a) live television digital or analog video/audio feed, (b) recorded digital or analog video/audio, (c) recorded audio, (d) graphic signals, (e) data signals and (f) web based application links;
one or more personal web enabled devices for accessing the packaged content;
a device for displaying packaged content simultaneously to serve as a menu for viewer's selection;
a means for deploying and presenting viewer selections from the menu; and
a means for the viewer to interact with the selected content.

2. A system according to claim 1 wherein the personal web enabled device is selected from the group consisting of: a cellular telephone; a smartphone; a personal digital assistant; internet television connected to a display; internet telephone, broadband instrument; and devices capable for recording onto at least one of: i-Pod, MP3 Player, CD Rom, DVD, DVD HD, Blue Ray, a hard disk, digital tape, or flash memory.

3. A system according to claim 2 wherein the means for packaging simultaneous streaming signals comprises a compression engine adapted to enable streaming on one channel.

4. A system according to claim 3 wherein the means for the viewer to interact with the selected content is selected from the group consisting of: a computer key board; a mouse pointing device; a roller ball pointing device; a touch screen; a computer remote control device; and a television remote control device.

5. A system according to claim 1 wherein the means for packaging simultaneous streaming signals contains a compression engine adapted to enable streaming on one channel.

6. A system according to claim 5 wherein the means for the viewer to interact with the selected content is selected from the group consisting of: a computer key board; a mouse pointing device; a roller ball pointing device; a touch screen; a computer remote control device; and a television remote control device

7. A system according to claim 1 wherein the means for the viewer to interact with the selected content is selected from the group comprising: a computer key board; a mouse pointing device; a roller ball pointing device; a touch screen; a computer remote control device; and a television remote control device.

8. A method for providing a single channel viewer controlled television broadcast carrier system, comprising the steps of:
generating packaged signals by packaging simultaneous streaming of a plurality of sources, at least one of which is chosen from the group consisting of: (a) live, multiple television digital or analog video/audio feeds, (b) recorded digital or analog video/audio, (c) recorded audio, (d) graphic signals, (e) data signals and (f) web based application links;
transmitting the packaged signals over a single channel to one or more viewers;
accessing the packaged content by the viewers;
displaying packaged content simultaneously to serve as a menu for viewer's selection;
deploying and presenting viewer selections from the menu; and
accepting viewer input from an input device to interact with the selected content to select the specific content that the viewer wants to view over a single channel.

9. A method according to claim 8 further comprising the step of compressing the packaged signals prior to transmitting.

10. A method according to claim 8 further comprising the steps of:
identifying a pre-determined primary signal from a live television broadcast feed embedded with a commercial segment;
delivering the primary signal into a pre-determined in-screen window in every viewer broadcast system;
preventing the stoppage of the play of the primary signal for the duration of the commercial segment; and
reverting back to the pre-commercial viewer screen configuration once the commercial segment is fully played.

11. A method of protecting commercial content in a viewer's controlled television broadcast system, comprising the steps of:
identifying a pre-determined primary signal from a live television broadcast feed embedded with the commercial segment;
delivering the primary signal into a pre-determined in-screen window in every viewer broadcast system;
preventing the stoppage of the play of the primary signal for the duration of the commercial segment; and
reverting back to the pre-commercial viewer screen configuration once the commercial segment is fully played.

12. A method according to claim 11, further comprising the step of generating a pre-determined primary signal.

13. A method according to claim 12 wherein the primary signal is selected from the group consisting of:
ads; billboards; tag lines; and meta data.

14. A method according to claim 11 wherein the primary signal is selected from the group consisting of:
ads; billboards; tag lines; or other meta data to be displayed.
